(19) United States
(12) Patent Application Publication
(10) Pub. No.: US 2007/0185621 A1
(43) Pub. Date: Aug. 9, 2007

(54) System and method for controlling injection into an irrigation system

(76) Inventor: Dan Gilmore, Granite Bay, CA (US)

Correspondence Address: Dan Gilmore, 8540 Willow Gate Ct., Granite Bay, CA, 95746-6135, US

(21) Appl. No.: 11/351,191

(22) Filed: Feb. 7, 2006

(51) Int. Cl. G05D 7/00; G05D 11/00

(52) U.S. Cl. 700/284

(57) ABSTRACT

A system and method for controlling irrigation injection for controlling irrigation injection including the transmission of an irrigation injection data signal including an injection instruction. The injection instruction may be calculated from various irrigation data including, but not limited to, landscape zone, sun radiation, root depth, soil condition, irrigation efficiency, slope, evapotranspiration data, historical weather data, projected weather data, and any combinations thereof. The system and method may further include the monitoring of irrigation flow of water.

### FIELD OF INVENTION

Embodiments of the present invention relate generally to controlling irrigation injection. More specifically, embodiments of the present invention relate to controlling the injection of products into an irrigation system by means of an irrigation controller that receives irrigation scheduling instruction from a weather or moisture monitoring device.

### BACKGROUND OF THE INVENTION

The world consumes billions of gallons of fresh water every day. Water conservation has become increasingly necessary as fresh water sources are limited and fully subscribed. Controlling irrigation watering schedules has become very important in order to improve the efficiency of irrigation systems and reduce non-point source pollution by reducing runoff.

There are several types of irrigation controllers that set the irrigation schedule either by a manual setting or automatically from external data. The manually set controllers do not automatically respond to changes in weather conditions or plant needs. The automatic controllers can be capable of responding to changes in weather conditions, soil moisture conditions or evapotranspiration which is the loss of water by evaporation from the soil and transpiration from plants. Because manual controllers require the homeowner or landscaper to adjust the watering times manually and they can be complex to operate, they do not lend themselves to conserving water. Automatic controllers are required to ensure the conservation of water used in landscape irrigation.

There are several methods of applying fertilizers, soil amendments, pest controls and a variety of other products to care for a landscape. Typically this is done manually on a periodic basis in heavy doses to provide an extended period between applications. Many of these products require heavy watering after they are applied when they are applied in these heavy amounts, to avoid plant damage. This practice is not consistent with the intent to conserve water and this is not a viable application option as water conservation practices are implemented.

There are also several types of irrigation injection devices that are used to inject fertilizers, soil amendments, pest controls and a variety of other products into the irrigation system. This method is superior to manual application because nutrients are typically delivered in smaller amounts with water so there is no heavy watering requirement to avoid plant damage. The injectors are activated when the irrigation controller starts the irrigation process and they either directly follow the irrigation schedule set by the irrigation controller or utilize a separate controller that is set manually in coordination with the irrigation controller. Because there is no automatic coordination between the irrigation schedule and the injection rate, the amount of injected product delivered through the irrigation system is inconsistent, resulting in less than optimum plant health, possible plant damage and potentially higher levels of non-point source pollution.

This invention creates coordination between irrigation schedule adjustments and the injection rate by automatically adjusting the injection rate as the irrigation schedule changes. This provides the consistent delivery of injected products based on their recommended application rates which results in healthier plant material and the elimination of non-point source pollution.

### OBJECTS AND ADVANTAGES

Accordingly, the objects and advantages of my invention are:
a) Provides the ability to automatically control the application of fertilizers and amendments to a landscape based on the irrigation schedule.
b) Automatically adjusts the injection rate when there are adjustments in the irrigation schedule.
c) Reduces the potential for plant damage due to over application of fertilizers or amendments.
d) Eliminates non-point source pollution caused by heavy applications of fertilizers and amendments.
e) Eliminates the complexity of making manual adjustments to coordinate the injection rate with the irrigation schedule.
f) Provides the ability to control multiple injectors in multiple locations that are injecting multiple products.
g) Eliminates the heavy watering required when fertilizers and amendments are applied periodically in dry form.

### SUMMARY OF THE INVENTION

An improved method of irrigation injection control that automatically adjusts the injection rate to coincide with irrigation schedule adjustments and the desired product application rate, by increasing injection rates when watering schedules are shortened and decreasing injection rates when watering schedules are lengthened. Injection rates are adjusted changing the time the injector operates or by changing the injection ratio.

Historical or projected water usage data is used to determine the injection rates for each irrigation zone by calculating the amount of water flow available to deliver the desired amount of injected product.

A better understanding of the objects, advantages, features, properties and relationships of the invention will be obtained from the following detailed description and accompanying drawings which set forth illustrative embodiments and which are indicative of the various ways in which the principles of the invention may be employed.

### BRIEF DESCRIPTION OF THE DRAWINGS

FIGS. 1, 2, 3 illustrate a system to control irrigation injection according to an embodiment of the present invention;

### DETAILED DESCRIPTION

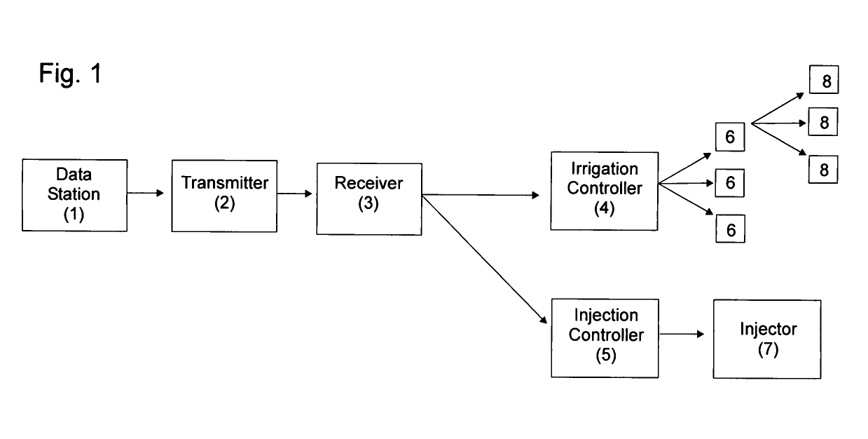

FIGS. 1-3 depict flow chart diagrams of the operation of systems according to an embodiment of the present invention. A data station 1 is in communication with a transmitter 2. The data station 1 may be a computer, network server, or any other type of apparatus or number of apparatuses that can perform calculations, store data, and communicate with a transmitter 2. Transmitter 2 is in communication with a receiver 3 which is in communication with at least one irrigation controller 4 and at least one injection controller 5 or irrigation and injection controller 9. Irrigation controller 4 is in communication with at least one or more sprinkler valves 6 and injection controller 5 or irrigation and injection controller 9 is in communication with injector 7. The sprinklers 8 may irrigate one or more types of crops or plants.

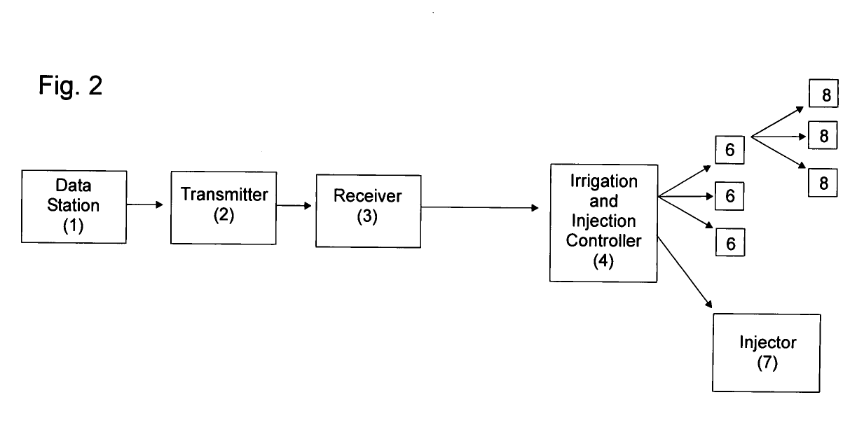

FIG. 2 depicts a flow chart diagram of the operation of a system according to an embodiment of the present invention that shows a system where receiver 3 is in communication with irrigation and injection controller 9. The irrigation and injection controller 9 is in communication with sprinkler valves 6 and injector 7.

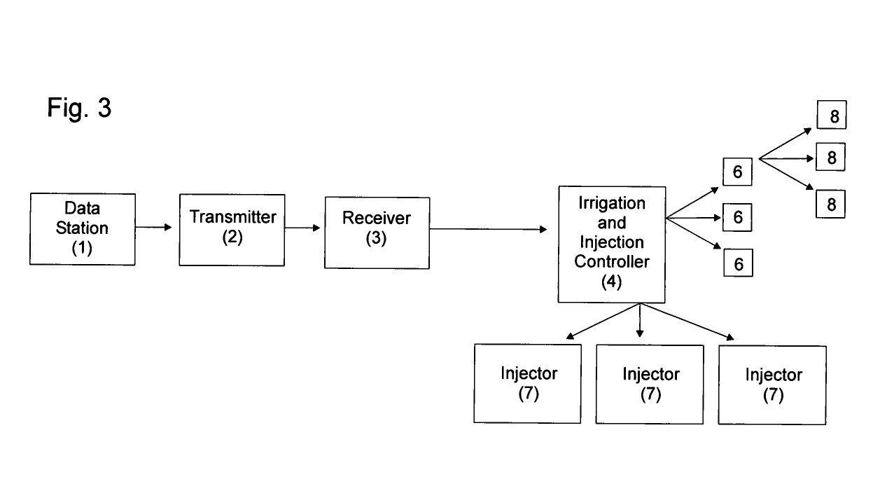

FIG. 3 depicts a flow chart diagram of the operation of a system according to an embodiment of the present invention that shows a system where irrigation and injection controller 9 is in communication with multiple injectors 7. This communication may be at the same time or at different times.

In an embodiment of the present invention, the transmitter 2 transmits at least one injection data signal to the receiver 3. The injection signal may be sent by any transmission method or medium including wireless, wired or any combination thereof. Examples of transmission methods and medium include optical wireless transmission, radio frequency transmission, optical wire transmission, electrical wire transmission, the Internet, electronic mail, a public or private telephone network, or any combination thereof.

The injection data signal includes an injection instruction. The injection instruction is an instruction to a particular controller to increase or decrease the time the injector operates or the ratio at which it injects. The injection instruction can be transmitted to multiple injection controllers at periodic intervals, at the same time or at varying times. The injection data signal can be specific to a single sprinkler zone, multiple sprinkler zones, a single injection controller or multiple injection controllers.

The injection instruction may be calculated from a variety of irrigation data including, but not limited to, type of plant material, maturity of plant material, desired product application rates, landscape zone, sun radiation, root depth, soil condition, irrigation efficiency, water source, slope, evapotranspiration data, historical water usage data, projected water usage data, historical weather data and projected weather data.

In another embodiment of the present invention, shown in FIG. 1, the injection data signal from data station 1 can be adjusted to increase or decrease the injection rate for single sprinkler valves 6 or multiple sprinkler valves 6. The data station could provide notification of when it is time to refill the injector and recommend the type and quantity of product to be put in the injector based on the collected data, anticipated weather conditions and the resulting condition of the landscape. The data station could notify the landscape owner or a service provider of when it is time to refill and they could schedule an injector refill or a product delivery.

In another embodiment of the present invention, shown in FIG. 3, the injection data signal from irrigation and injection controller 9 can be adjusted to increase or decrease the injection rate for multiple injectors in multiple locations or multiple injectors in one or more locations injecting multiple products.

### Summary, Ramifications, and Scope

Accordingly, the reader will see that the system and method for controlling injection into an irrigation system will provide advantages to consumers, industry and the environment. It provides a means of controlling the distribution of fertilizers, soil amendments, pest controls and a variety of other products to care for a landscape based on the irrigation schedule and the recommended application rate of the various injected products. Injection rates adjust automatically when irrigation schedules are adjusted due to weather conditions and plant water requirements, which prevent plant damage and non-point source pollution while it promotes optimum plant health.

While the above description contains much specificity, these should not be construed as limitations on the scope of the invention, but rather as an exemplification of one preferred embodiment thereof. Many other variations are possible.

Accordingly, the scope of the invention should be determined not by the embodiments illustrated, but by the appended claims and their legal equivalents.

1-25. (canceled)

26. A method for controlling irrigation injection, comprising: transmitting an injection data signal;
receiving the injection data signal;
and adjusting an injection schedule based upon said injection data signal to provide an adjusted injection rate, wherein said injection data signal includes an injection instruction determined from irrigation data including landscape zone, plant type, sun radiation, root depth, soil condition, irrigation efficiency, slope, evapotranspiration data, historical weather data, projected weather data, and any combinations thereof.

27. The method as recited in claim 26, wherein each of the steps are performed automatically.

28. The method as recited in claim 26, wherein said injection instruction is selected from the group consisting of time instruction, injection ratio instruction and a time and injection ratio instruction.

29. The method as recited in claim 26, further comprising said injection instruction determined by historical irrigation data.

30. The method as recited in claim 26, further comprising: determining said injection instruction from monitoring an irrigation flow; transmitting a water flow message; and receiving said water flow message.

31. The method as recited in claim 26, wherein said injection data signal is transmitted via a method including transmission over the Internet.

32. The method as recited in claim 26, wherein said injection data signal is transmitted via a method selected from the group consisting of optical wireless transmission, radio frequency transmission, optical wire transmission, electrical wire transmission, or a combination thereof.

33. A method as recited in claim 26, comprising: transmitting said injection data signal including said injection instruction to a receiver in communication with a controller.

34. A method for controlling irrigation injection comprising: a data station; a first transmitter in communication with the data station, a first receiver in communication with said first transmitter; and one or more controllers in communication with said first receiver, wherein said first transmitter transmits an injection data signal including an irrigation injection instruction determined from irrigation data including landscape zone, plant type, sun radiation, root depth, soil condition, irrigation efficiency, slope, evapotranspiration data, historical weather data, projected weather data, and any combinations thereof, to said first receiver.

35. The system as recited in claim 34, wherein said one or more controllers are in communication with at least one sprinkler.

36. The system as recited in claim 34, further comprising at least one additional receiver in communication with the first transmitter and in communication with at least one of the one or more controllers.

37. The system as recited in claim 34, further comprising at least one additional transmitter in communication with said first receiver and in communication with said data station.

38. The system as recited in claim 34, further comprising, a second transmitter in communication with said controller, and a second receiver in communication with said data station, wherein said second transmitter transmits a controller information message to said second receiver.

39. A method for controlling irrigation injection of one or more remote controllers for irrigation injection comprising: determining an irrigation injection instruction from irrigation data; transmitting an injection data signal including said injection instruction to one or more receivers, wherein said one or more receivers are in communication with said one or more remote controllers; receiving said injection data signal, wherein said injection data signal includes said injection instruction determined from irrigation data including landscape zone, plant type, sun radiation, root depth, soil condition, irrigation efficiency, slope, evapotranspiration data, historical weather data, projected weather data, and any combinations thereof; and adjusting an injection rate based upon the injection data signal to provide an adjusted injection rate.

40. The method recited in claim 39, wherein said one or more controllers are portable.

41. The method as recited in claim 39, wherein said injection data signal is transmitted via a method including transmission over the Internet.
